(19) United States
(12) Patent Application Publication
(10) Pub. No.: US 2016/0284146 A1
(43) Pub. Date: Sep. 29, 2016

(54) ACCESS AUTHORIZATION BASED ON PHYSICAL LOCATION

(71) Applicant: International Business Machines Corporation, Armonk, NY (US)

(72) Inventors: David P. Moore, Burleigh Waters (AU); Craig Pearson, Varsity Lakes (AU)

(21) Appl. No.: 14/974,083

(22) Filed: Dec. 18, 2015

Related U.S. Application Data
(63) Continuation of application No. 14/670,793, filed on Mar. 27, 2015.

(51) Int. Cl. G07C 9/00

(52) U.S. Cl. CPC G07C 9/00174

(57) ABSTRACT

An approach for access authorization to a protected resource is provided. The approach provisions a physical access badge identifier to a door controller. The approach receives a swipe event, wherein the swipe event includes a door controller identifier and the physical access badge identifier. The approach creates an authorization request to access a protected resource, wherein the authorization request includes a request from a user for access to a protected resource. The approach identifies one or more security policies for the protected resource. The approach determines whether to permit access to the protected resource based, at least in part, on the one or more security policies and the swipe event. Responsive to a determination to permit access to the protected resource, the approach permits access to the protected resource, wherein permitting access to the protected resource includes validating an authentication session for a user.

### BACKGROUND OF THE INVENTION

The present invention relates generally to security systems, and more particularly to access authorization based on a physical location.

In some instances, it may be important for organizations with a requirement for strong security at physical sites and enterprise information technology (IT) applications and environments to converge management and operation of physical access control systems (PACS) with logical (i.e., IT) security systems.

Some solutions may address aspects of security convergence from the perspective of streamlining an employee provisioning lifecycle. These solutions may employ extensions or variations of identity management (IDM) to manage physical and logic access entitlements for employees. Vendors may support heterogeneous IT environments and multiple physical sites where each site may have physical security systems from separate vendors.

Some other solutions may address access to IT resource reaction based on physical room location using a physical access card (e.g., badge) as a type of authentication token. For example, when a badge is swiped, some solution may be able to leverage the authentication token to enable access to an enterprise network.

### SUMMARY

Aspects of an embodiment of the present invention disclose a method, a computer system, and a computer program product for access authorization to a protected resource, in accordance with an embodiment of the present invention. The method includes provisioning, by one or more computer processors, a physical access badge identifier to a door controller, wherein provisioning includes created one or more user accounts, wherein the one or more user accounts includes at least an employee ID, an authorization level, and a user access password; retrieving user information from the one or more user accounts associated with a user; associating the physical access badge identifier with user information from the one or more user accounts associated with the user; and storing the one or more user accounts associated with the user in a database. The method includes receiving, by one or more computer processors, a swipe event, wherein the swipe event includes a door controller identifier and the physical access badge identifier, wherein receiving includes sending the swipe event to a physical access control system; and storing the door controller identifier and the physical access badge identifier in a database. The method includes creating, by one or more computer processors, an authorization request to access a protected resource, wherein the authorization request includes a request from a user for access to a protected resource. The method includes identifying, by one or more computer processors, one or more security policies for the protected resource, wherein identifying includes retrieving a physical access badge identifier for a user from a database; retrieving a swipe event associating with the physical access badge identifier for the user; and identifying the one or more security policies for the protected resource associated with the physical access badge identifier of the user and the swipe event. The method includes determining, by one or more computer processors, whether to permit access to the protected resource based, at least in part, on the one or more security policies and the swipe event. Responsive to a determination to permit access to the protected resource, the method includes permitting, by one or more computer processors, access to the protected resource, wherein permitting access to the protected resource includes validating an authentication session for a user.

### BRIEF DESCRIPTION OF THE DRAWINGS

FIG. 1 is a functional block diagram illustrating a data processing environment, generally designated 100, in accordance with an embodiment of the present invention.

FIG. 2 is a functional flow diagram illustrating steps of an access program, such as the access program of FIG. 1, generally designated 200, for access authorization based on a physical location, in accordance with an embodiment of the present invention.

FIG. 3 is a flowchart depicting operational steps of an access program, such as the access program of FIG. 1, generally designated 300, for access authorization to a protected resource, in accordance with an embodiment of the present invention.

FIG. 4 is a block diagram depicting components of a data processing system (such as the server of FIG. 1), generally designated 400, in accordance with an embodiment of the present invention.

### DETAILED DESCRIPTION

Implementation of embodiments of the present invention may take a variety of forms, and exemplary implementation details are discussed subsequently with reference to the Figures.

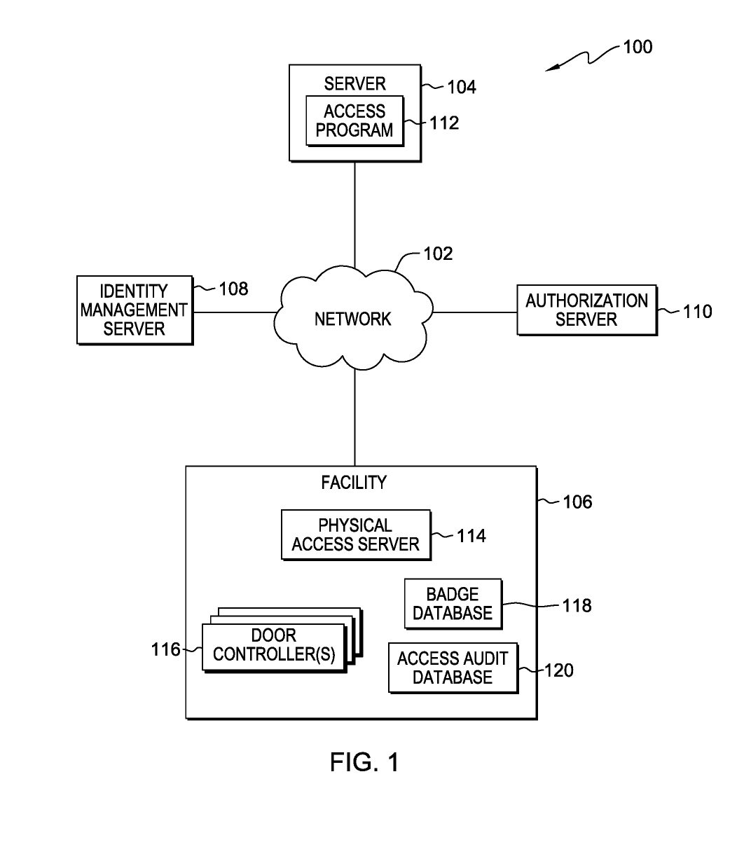

FIG. 1 is a functional block diagram illustrating a data processing environment, generally designated 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims. FIG. 1 includes network 102, server 104, facility 106, identity management server 108, and authorization server 110. In one embodiment, the functions and capabilities of each of the components in FIG. 1 may be located on once device, such as server 104, physical access server 114 of facility 106, identity management server 108, and authorization server 110.

In the exemplary embodiment, network 102 is the Internet representing a worldwide collection of networks and gateways that use TCP/IP protocols to communicate with one another. Network 102 may include wire cables, wireless communication links, fiber optic cables, routers, switches and/or firewalls. Server 104, physical access server 114 of facility 106, identity management server 108, authorization server 110, badge database 118 of facility 106, and access audit database 120 of facility 106 are interconnected by network 102. Network 102 can be any combination of connections and protocols capable of supporting communications between server 104, physical access server 114 of facility 106, identity management server 108, authorization server 110, badge database 118 of facility 106, access audit database 120 of facility 106, and access program 112. Network 102 may also be implemented as a number of different types of networks, such as an intranet, a local area network (LAN), a virtual local area network (VLAN), or a wide area network (WAN). FIG. 1 is intended as an example and not as an architectural limitation for the different embodiments.

In the exemplary embodiment, server 104 may be, for example, a server computer system such as a management server, a web server, or any other electronic device or computing system capable of sending and receiving data. In another embodiment, server 104 may be a data center, consisting of a collection of networks and servers providing an IT service, such as virtual servers and applications deployed on virtual servers, to an external party. In another embodiment, server 104 represents a “cloud” of computers interconnected by one or more networks, where server 104 is a computing system utilizing clustered computers and components to act as a single pool of seamless resources when accessed through network 102. This is a common implementation for data centers in addition to cloud computing applications. In the exemplary embodiment, server 104 includes access program 112 for access authorization based on a physical location and a physical access badge.

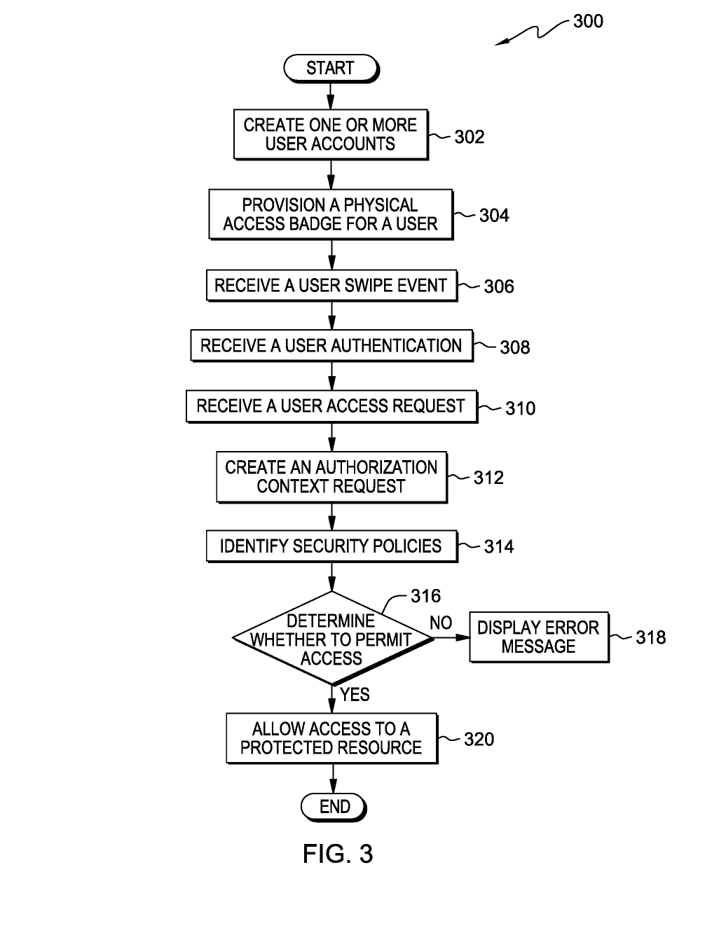

In the one embodiment, access program 112 operates on a central server, such as server 104, and can be utilized by one or more client computers, identity management server 108, authorization server 110, and physical access server 114 via a network, such as network 102. In one embodiment, access program 112 may be a software-based program, downloaded from a central server, such as server 104, and installed on one or more client computers, such as identity management server 108, authorization server 110, and physical access server 114 via a network, such as network 102. In yet another embodiment, access program 112 may be utilized as a software service provided by a third-party cloud service provider (not shown). In one embodiment, access program 112 may be a web/HTTP server deployed to enforce authentication and authorization of an access request to a protected IT resource. In one embodiment, access program 112 utilizes an identity management server, such as identity management server 108, an authorization server, such as authorization server 110, or any other information source server as part of its capabilities related to enforcement (i.e., enforcement functionality). In one embodiment, access program 112 performs operational steps, such as the operational steps discussed in further detail in reference to FIG. 3, through employment of capabilities provided by one or more components, such as identity management server 108, authorization server 110, physical access server 114, door controller(s) 116, badge database 118, and access audit database 120, etc.

In the one embodiment, access program 112 is a software based component utilized by a server, such as server 104, for providing software application access authorization based on a physical access badge and a physical location. In the exemplary embodiment, access program 112 provides the capability to combine traditional identity management provisioning technology with physical access control systems (PACS) and IT security access control systems to enable IT application access authorization decisions to consider a physical context of a user (i.e., user location). In one embodiment, access program 112 provides the capability to augment IT security access control authorization with physical context of an access. In one embodiment, access program 112 determines a physical room location of the access based, at least in part, on a user's badge swipe audit events recorded by a physical access control system, such as physical access server 114, and permits or denies IT application access based on the user's badge swipe (i.e., user authorization). In some embodiments, access program 112 may consider additional badge swipes from additional users requesting access to enter the same location as a user currently accessing an IT application when determining to permit or deny IT application access. In some embodiments, access program 112 may be fully integrated, partially integrated, or separate from a physical access control system, such as physical access server 114, an information technology (IT) security system, an identity management server, such as identity management server 108, and an authorization server, such as authorization server 110. In one embodiment, access program 112 may be an application, downloaded from an application store or third party provider, capable of being used in conjunction with a physical access control system, such as physical access server 114, an IT security system, an identity management server, such as identity management server 108, and an authorization server, such as authorization server 110.

In the exemplary embodiment, facility 106 represents a physical location, such as a building, a house, a room, etc., or any other type of structure that contains some level of physical security infrastructure. In one embodiment, facility 106 represents a facility that includes a dedicated physical security system. Facility 106 includes physical access server 114, door controller(s) 116, badge database 118, and access audit database 120. In the exemplary embodiment, badge database 118 is a conventional database for storing one or more badge identifiers for one or more authenticated users.

In the exemplary embodiment, physical access server 114 is a physical access control system (PACS) that allows access to physical facilities of an organization or entity (e.g., government, commercial, or private). In one embodiment, physical access server 114 provides a user with the capability to gain access to resources, location, and assets of the entity through various access means, such as ID's, badges, access cards, passwords, and biometric data, etc. In one embodiment, physical access server 114 may be a managed physical security system (MPSS) that is managed by a standard policy-based software application to apply uniform security policies. In some embodiments, physical access server 114 may be a client computer, such as a workstation, a personal computer, or a laptop computer. In another embodiment, physical access server 114 may be utilized by any other suitable computing device or mobile computing device capable of communicating with one or more electronic devices.

In the exemplary embodiment, door controller(s) 116 is a conventional badge reader access point. In one embodiment, door controller(s) 116 can be a card reader, where a card reader is a data input device that retrieves data from a card shaped storage medium, where the card shaped storage medium may take the form of a postal stamp sized storage medium, an identification card sized storage medium, such as a badge or driver's license, a passport sized storage medium, a greeting card sized storage medium, or any other card shaped storage medium of suitable size. In another embodiment, door controller(s) 116 may be any electronic device capable of retrieving information from a card (i.e., badge) embedded with a barcode, magnetic strip, computer chip, or any other suitable storage medium. In one embodiment, door controller(s) 116 may include a user interface, where a user interface refers to the information (such as graphic, text, and sound) a program presents to a user and the control sequences the user employs to control the program. There are many types of user interfaces. In one embodiment, the user interface may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computer, GUIs were introduced in reaction to the perceived steep learning curve of command-line interfaces, which required commands to be typed on the keyboard. The actions in GUIs are often performed through direct manipulation of the graphics elements.

In the exemplary embodiment, identity management server 108 may be, for example, a server computer system such as a management server, a web server, or any other electronic device or computing system capable of sending and receiving data. In another embodiment, authorization server 110 may be a data center, consisting of a collection of networks and servers providing an IT service, such as virtual servers and applications deployed on virtual servers, to an external party. In another embodiment, identity management server 108 represents a “cloud” of computers interconnected by one or more networks, where identity management server 108 is a computing system utilizing clustered computers and components to act as a single pool of seamless resources when accessed through network 102. This is a common implementation for data centers in addition to cloud computing applications. In one embodiment, identity management server 108 provides the capability to provision user access to IT and physical access control systems, such as physical access server 114.

In the exemplary embodiment, authorization server 110 may be, for example, a server computer system such as a management server, a web server, or any other electronic device or computing system capable of sending and receiving data. In another embodiment, authorization server 110 may be a data center, consisting of a collection of networks and servers providing an IT service, such as virtual servers and applications deployed on virtual servers, to an external party. In another embodiment, authorization server 110 represents a “cloud” of computers interconnected by one or more networks, where authorization server 110 is a computing system utilizing clustered computers and components to act as a single pool of seamless resources when accessed through network 102. This is a common implementation for data centers in addition to cloud computing applications. In one embodiment, authorization server 110 provides the capability to identify and manage authorization context and security policies that are applicable to a protected IT resource (not shown). In one embodiment, authorization server 110 represents a policy decision point (PDP), where the PDP stores access policies (e.g., security policies) in a database (not shown), where the access policies contain rules that are express in terms of real time or static context data in any suitable policy representation format known in the art.

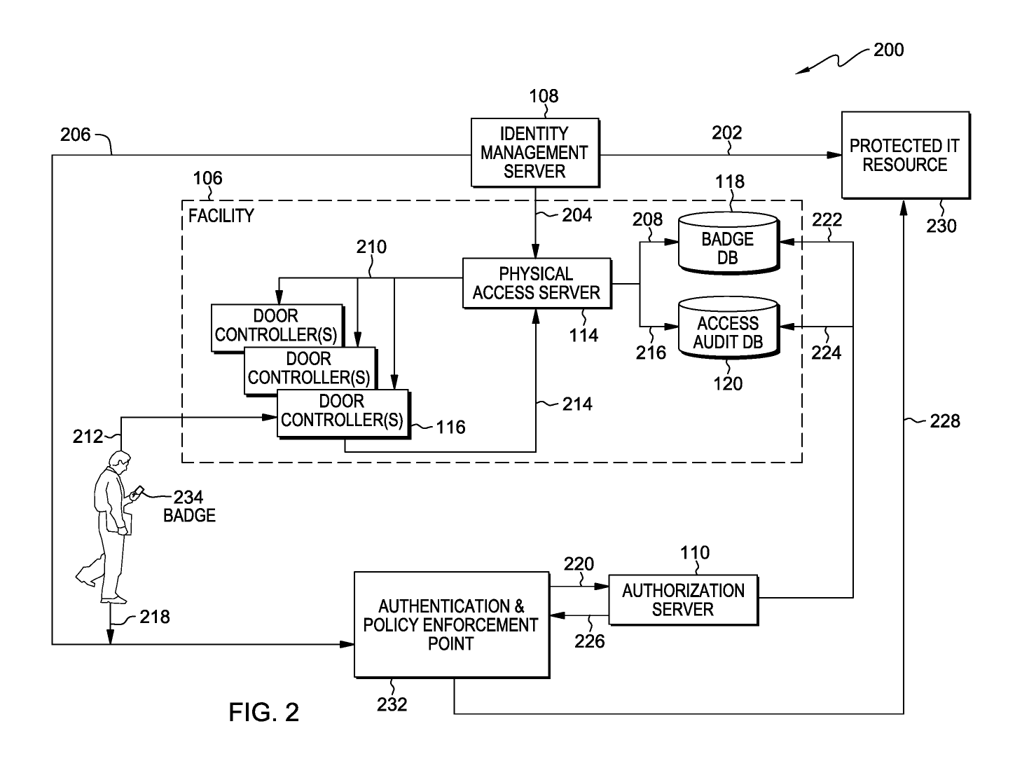

FIG. 2 is a functional flow diagram illustrating the operational steps of an access program, such as the access program of FIG. 1, generally designated 200, for access authorization based on a physical location, in accordance with an embodiment of the present invention.

Access program 112 provisions user access to IT and physical access control systems. In one embodiment, access program 112 provisions user access to IT and physical access control systems, such as physical access server 114, by employing capabilities provided by an identity management server, such as identity management server 108. In one embodiment, access program 112 creates a user account for a user in a protected IT resource server, such as protected IT resource 230 utilizing capabilities provided by identity management server 108 (202). In one embodiment, access program 112 creates a user account for the user in a physical access control system server, such as physical access server 114, utilizing capabilities provided by identity management server 108 (204). In one embodiment, access program 112 creates a user account for the user in an authentication and policy enforcement point, such as authentication and policy enforcement point 232, utilizing capabilities provided by identity management server 108 (206).

Access program 112 provisions a physical access badge identifier for a user. In one embodiment, access program 112 provisions the physical access badge identifier for a user by associating the user's account with a physical access badge identifier. In one embodiment, access program 112 stores the physical access badge identifier for a user in a badge database, such as badge database 118 (208). In one embodiment, access program 112 provisions the physical access badge identifier to a physical access site door controller(s), such as door controller(s) 116 of facility 106 (210).

Responsive to a user swiping a physical badge, such as badge 234, access program 112 receives a user swipe event at a door controller(s) of a facility, such as door controller(s) 116 of facility 106 (212).

Responsive to receiving a user swipe event, access program 112 sends the user swipe event to a physical access control system, such as physical access server 114 (214). In one embodiment, access program 112 stores a door identifier and a badge identifier in a real time badge access audit database, such as access audit database 120 (216).

Access program 112 receives a user authentication (i.e., a user password) and a user access request at an authentication and policy enforcement point, such as authentication and policy enforcement point 232 (218).

Responsive to receiving the user authentication and the user access request, access program 112 creates an authorization context request and sends the authorization context request to an authorization server, such as authorization server 110 (220).

Access program 112 identifies one or more security policies that are applicable to a protected IT resource a user is requesting access, such as protected IT resource 230. In one embodiment, access program 112 identifies one or more security policies that are applicable to the protected IT resource by retrieving a badge identifier for the user from a badge database, such as badge database 118, utilizing capabilities provided by an authorization server, such as authorization server 110 (222), and retrieving a user swipe event associated with the badge identifier from a real time badge access audit database, such as access audit database 120 (224).

Access program 112 evaluates the one or more security policy rules that govern access to the protected IT resource, such as protected IT resource 230, based on the physical context (i.e., location) of a room, utilizing capabilities provided by an authorization server, such as authorization server 110, and determines whether to permit access (226). In one embodiment, access program 112 sends a determination (i.e., permit or deny) to an authentication and policy enforcement point, such as authentication and policy enforcement point 232 utilizing capabilities provided by authorization server 110.

Responsive to a determination to permit access to the protected IT resource, access program 112 allows access to the protected IT resource, such as protected IT resource 230 via the authentication and policy enforcement point, such as authentication and policy enforcement point 232 (228).

FIG. 3 is a flowchart depicting operational steps of an access program, such as the access program of FIG. 1, generally designated 300, for access authorization to a protected resource, in accordance with an embodiment of the present invention.

Access program 112 creates one or more user accounts (302). In the exemplary embodiment, responsive to receiving user input to provision user access to IT and physical access control systems, such as physical access server 114, access program 112 creates one or more user accounts utilizing capabilities provided by an identity management server, such as identity management server 108. In one embodiment, access program 112 creates a user account for a user in a protected IT resource server, such as protected IT resource 230 of FIG. 2. In one embodiment, access program 112 creates a user account for the user in a physical access control system server, such as physical access server 114. In one embodiment, access program 112 creates a user account for the user in an authorization server, such as authorization server 110. In one embodiment, the user account includes user information, where the user information includes, without limitation, an employee ID, an authorization level, a user access password, and an account password, etc.

Access program 112 provisions a physical access badge for a user (304). In the exemplary embodiment, access program 112 provisions a physical access badge identifier for a user by retrieving user information from the user account associated with the user utilizing capabilities provided by an identity management server, such as identity management server 108. In one embodiment, access program 112 stores the user account to badge mapping within a badge database, such as badge database 118. In one embodiment, access program 112 provisions the physical access badge identifier to a door controller at a physical access site, such as door controller(s) 116 of facility 106, based on an authorization level retrieved from the user account utilizing capabilities provided by an identity management server, such as identity management server 108. In some embodiments, access program 112 associates the physical access badge identifier with the user account and stores the association in an identity management server, such as identity management server 108.

Access program 112 receives a user swipe event (306). In the exemplary embodiment, access program 112 receives a user swipe event from a user via a badge, such as badge 234 of FIG. 2, via a door controller of a facility, such as door controller(s) 116 of facility 106 utilizing capabilities provided by a physical access control system, such as physical access server 114. In one embodiment, the user swipe event includes a door controller identifier (i.e., a room identifier) and a badge identifier. In one embodiment, access program 112 sends the user swipe event to a physical access control system, such as physical access server 114. In one embodiment, access program 112 stores the door controller identifier and the badge identifier in a real time badge access audit database, such as access audit database 120, utilizing capabilities provided by a physical access control system, such as physical access server 114.

Access program 112 receives a user authentication (308). In the exemplary embodiment, access program 112 receives a user authentication (i.e., password) via an authentication and policy enforcement point, such as authentication and policy enforcement point 232 of FIG. 2. In one embodiment, the user authentication is a user password from the user account stored in an identity management server, such as identity management server 108.

Access program 112 receives a user access request (310). In the exemplary embodiment, access program 112 receives a user access request for a protected IT resource, such as protected IT resource 230 of FIG. 2, via an authentication and policy enforcement point, such as authentication and policy enforcement point 232 of FIG. 2. In one embodiment, the user access request includes, without limitation, a resource identifier that identifies the protected IT resource the user wants to access, a user name, and a user password, etc.

Access program 112 creates an authorization context request (312). In the exemplary embodiment, responsive to receiving a user access request, access program 112 creates an authorization context request utilizing capabilities provided by an authentication and policy enforcement point, such as authentication and policy enforcement point 232 of FIG. 2. In one embodiment, the authorization context request includes a user identifier, such as a user name, for the user requesting access to the protected IT resource. In one embodiment, access program 112 sends the authorization context request to an authorization server, such as authorization server 110, utilizing capabilities provided by the authentication and policy enforcement point, such as authentication and policy enforcement point 232 of FIG. 2.

Access program 112 identifies security policies (314). In the exemplary embodiment, access program 112 identifies one or more security policies applicable to a protected IT resource, such as protected IT resource 230 of FIG. 2, via an authorization server, such as authorization sever 110. In one embodiment, the one or more security policies may be system defined (e.g., default security system policies), facility specific (e.g., company defined security system policies), and user defined. In one embodiment, the one or more security policies are associated with a badge identifier and a user swipe event. In one embodiment, access program 112 retrieves a badge identifier for a user, via an authorization server, such as authorization server 110, from a badge database, such as badge database 118. In one embodiment, access program 112 retrieves a user swipe event associated with the badge identifier for the user, where the user swipe event identifies a physical location (i.e., room), and is the most recent swipe event associated with the badge identifier, via an authorization server, such as authorization server 110, from a badge access audit database, such as access audit database 120. In another embodiment, access program 112 retrieves a plurality of badge identifiers for users currently in a room, such as facility 106, utilizing the capabilities provided by an identity management server, such as identity management server 108, and for each of the plurality of badge identifiers, retrieve an associated user identifier (e.g., a user name) and an authorization level (i.e., level of security clearance) associated with each user identifier.

Access program 112 determines whether to permit access (316). In the exemplary embodiment, access program 112 determines whether to permit access to a user by evaluating one or more security policies applicable to a protected IT resource identified in the user access request, such as protected IT resource 230 of FIG. 2, utilizing capabilities provided by an authorization server, such as authorization sever 110, wherein permitting access includes validating an authentication session for the user. In one embodiment, the one or more security policies include rules for permitting access. For example, the one or more security policies for a protected IT resource, such as protected IT resource 230 of FIG. 2, may include a rule, such as “authenticated users possessing a level of security clearance N may access protected IT resource 230 from a room X, as long as the room X does not contain additional individuals possessing a level of security clearance less than N”. In an alternative embodiment, access program 112 determines whether to permit access to a user by evaluating one or more security policies based on a room location. For example, access program 112 may evaluate the one or more security policies for a protected IT resource, such as protected IT resource 230 of FIG. 2, based on a room location, such as where the one or more security policies include a rule stating “authenticated users possessing a level of security clearance Q may access protected IT resource 230 only from room Z, as long as room Z does not contain additional individuals possessing a level of security clearance less than Q”. In one embodiment, access program 112 evaluates the one or one security policies based on one or more badge identifiers, one or more user identifiers (e.g., a user name) associated with the one or more badge identifiers, and a level of security clearance (e.g., top secret, secret, privileged, low, etc.) associated with the one or more user identifiers retrieved from a user account, such as a user account stored for a user in an authorization server, such as authorization server 110, and a badge database, such as badge database 118. In one embodiment, where access program 112 determines that a level of security clearance associated with a user and a physical location of the user (i.e., a physical location indicated by a user swipe event) conform with the one or more security policies for a protected IT resource, access program 112 permits access to the protected IT resource by validating an authentication session for the user. In one embodiment, where access program 112 determines that a level of security clearance associated with a user and a physical location of the user do not conform with the one or more security policies for a protected IT resource, access program 112 denies the user access to the protected IT resource by invalidating an authentication session for the user.

Responsive to a determination to deny a user access to a protected IT resource (NO branch, 316), access program 112 displays an error message (318). In one embodiment, access program 112 displays an error message at a door controller, such as door controller(s) 116 of facility 106 via a user interface, denying the user access to the protected IT resource by invalidating an authentication session for the user. In another embodiment, access program 112 displays an error message at an authentication and policy enforcement point, such as authentication and policy enforcement point 232 of FIG. 2. In one embodiment, the error message may include reasons why access is denied, such as “invalid authentication”.

Responsive to a determination to permit a user access to a protected IT resource (YES branch, 316), access program 112 allows a user access to the protected IT resource via an authentication and policy enforcement point, such as authentication and policy enforcement point 232 of FIG. 2 (320). In one embodiment, access program 112 allows a user to access the protected IT resource, such as protected IT resource 230, by allowing access to a facility via a door controller, such as facility 106 via door controller(s) 116, where allowing access includes validating an authentication session for the user, and may further include unlocking a door and disabling security protocols on the protected IT resource.

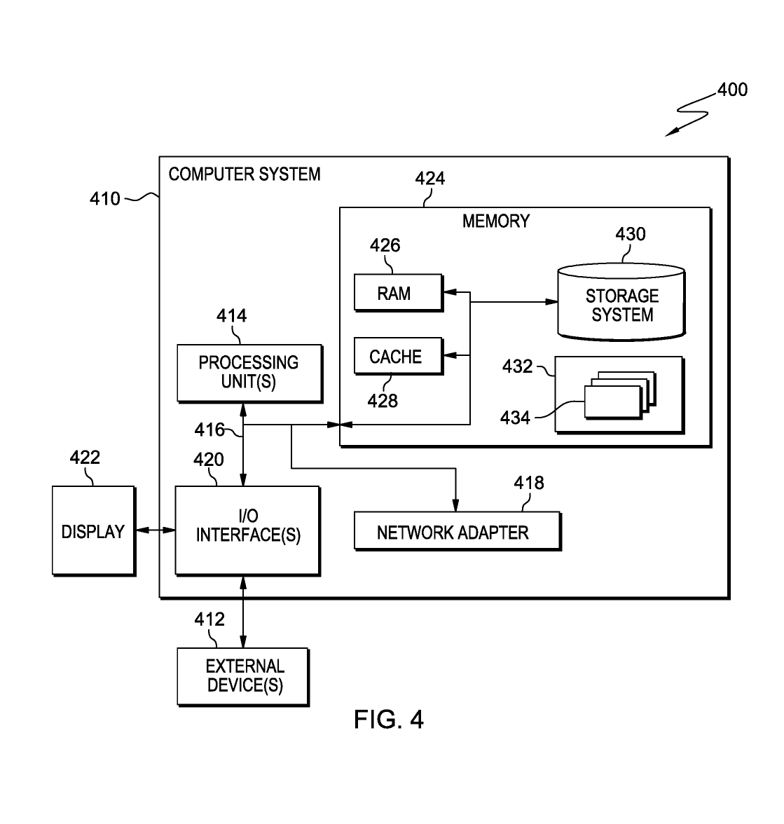

FIG. 4 is a block diagram 400 depicting components of a data processing system, such as server 104, identity management server 108, authorization server 110, and physical access server 114 of FIG. 1, generally designated as computer system 410, in accordance with an embodiment of the present invention. It should be appreciated that FIG. 4 provides only an illustration of one implementation and does not imply any limitations with regard to the environments in that different embodiments may be implemented. Many modifications to the depicted environment may be made.

In the illustrative embodiment, computer system 410 is shown in the form of a general-purpose computing device. The components of computer system 410 may include, but are not limited to, one or more processors or processing unit 414, memory 424, and bus 416 that couples various system components including memory 424 to processing unit(s) 414.

Bus 416 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system 410 typically includes a variety of computer system readable media. Such media may be any available media that is accessible by computer system 410, and it includes both volatile and non-volatile media, removable and non-removable media.

Memory 424 can include computer system readable media in the form of volatile memory, such as random access memory (RAM) 426 and/or cache memory 428. Computer system 410 may further include other removable/non-removable, volatile/non-volatile computer system storage media. By way of example only, storage system 430 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 416 by one or more data media interfaces. As will be further depicted and described below, memory 424 may include at least one computer program product having a set (e.g., at least one) of program modules that are configured to carry out the functions of embodiments of the invention.

Program/utility 432, having one or more sets of program modules 434, may be stored in memory 424 by way of example, and not limitation, as well as an operating system, one or more application programs, other program modules, and program data. Each of the operating systems, one or more application programs, other program modules, and program data, or some combination thereof, may include an implementation of a networking environment. Program modules 434 generally carry out the functions and/or methodologies of embodiments of the invention as described herein. Computer system 410 may also communicate with one or more external device(s) 412 such as a keyboard, a pointing device, a display 422, etc., or one or more devices that enable a user to interact with computer system 410 and any devices (e.g., network card, modem, etc.) that enable computer system 410 to communicate with one or more other computing devices. Such communication can occur via Input/Output (I/O) interface(s) 420. Still yet, computer system 410 can communicate with one or more networks such as a local area network (LAN), a general wide area network (WAN), and/or a public network (e.g., the Internet) via network adapter 418. As depicted, network adapter 418 communicates with the other components of computer system 410 via bus 416. It should be understood that although not shown, other hardware and software components, such as microcode, device drivers, redundant processing units, external disk drive arrays, RAID systems, tape drives, and data archival storage systems may be used in conjunction with computer system 410.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

The terminology used herein is for the purpose of describing particular embodiments only and is not intended to be limiting of the invention. It should be appreciated that any particular nomenclature herein is used merely for convenience and thus, the invention should not be limited to use solely in any specific function identified and/or implied by such nomenclature. Furthermore, as used herein, the singular forms of “a”, “an”, and “the” are intended to include the plural forms as well, unless the context clearly indicates otherwise.

1. A method for access authorization to a protected resource, the method comprising:
provisioning, by one or more computer processors, a physical access badge identifier to a door controller, wherein provisioning a physical access badge identifier to a door controller, includes:
creating, by one or more computer processors, one or more user accounts, wherein the one or more user accounts includes at least an employee ID, an authorization level, and a user access password;
retrieving, by one or more computer processors, user information from the one or more user accounts associated with a user;
associating, by one or more computer processors, the physical access badge identifier with user information from the one or more user accounts associated with the user; and
storing, by one or more computer processors, the one or more user accounts associated with the user in a database;
receiving, by one or more computer processors, a swipe event, wherein the swipe event includes a door controller identifier and the physical access badge identifier, wherein receiving a swipe event, includes:
sending, by one or more computer processors, the swipe event to a physical access control system; and
storing, by one or more computer processors, the door controller identifier and the physical access badge identifier in a database;
creating, by one or more computer processors, an authorization request to access a protected resource, wherein the authorization request is created in response to receiving a request from a user for access to a protected resource from a first room, and wherein the protected resource is an information technology (IT) application accessible only in the first room;
identifying, by one or more computer processors, one or more security policies for the protected resource, wherein identifying one or more security policies for the protected resource, includes:
retrieving, by one or more computer processors, a physical access badge identifier for a user from a database;
retrieving, by one or more computer processors, a swipe event associated with the physical access badge identifier for the user from a database, wherein the swipe event identifies a physical location for a most recent swipe event associated with the physical access badge identifier; and
identifying, by one or more computer processors, the one or more security policies for the protected resource associated with the physical location of the physical access badge identifier of the user and the swipe event;
determining, by one or more computer processors, whether to permit access to the protected resource based, at least in part, on the one or more security policies and the swipe event, wherein determining whether to permit access to the protected resource includes at least retrieving, by one or more computer processors, a plurality of badge identifiers for other users currently located in the first room with the user and comparing the plurality of badge identifiers for other users to the one or more security policies for the protected resource;
responsive to a determination to permit access to the protected resource, permitting, by one or more computer processors, access to the protected resource, wherein permitting access to the protected resource includes validating an authentication session for a user; and
responsive to a determination to not permit access to the protected resource, denying, by one or more computer processors, access to the protected resource, wherein denying access to the protected resource includes invalidating an authentication session for a user.
